(19) United States
(12) Patent Application Publication
(10) Pub. No.: US 2020/0257450 A1
(43) Pub. Date: Aug. 13, 2020

(54) DATA HIERARCHICAL STORAGE AND HIERARCHICAL QUERY METHOD AND APPARATUS

(71) Applicant: ALIBABA GROUP HOLDING LIMITED, George Town (KY)

(72) Inventors: Jienan ZENG, Hangzhou (CN); Chuangxian WEI, Hangzhou (CN); Jiye TU, Hangzhou (CN); Chaoqun ZHAN, Hangzhou (CN)

(21) Appl. No.: 16/862,163

(22) Filed: Apr. 29, 2020

Related U.S. Application Data
(63) Continuation of application No. PCT/CN2018/110968, filed on Oct. 19, 2018.

(30) Foreign Application Priority Data
Oct. 30, 2017 (CN) 201711036438.5

(51) Int. Cl. G06F 3/06

(52) U.S. Cl. CPC G06F 3/064; G06F 3/0653; G06F 3/067; G06F 3/0619; G06F 3/0685; G06F 3/0652

(57) ABSTRACT

Embodiments of the present disclosure can provide a method and an apparatus for data hierarchical storage. The method comprises: storing one or more data files in a remote disk; acquiring, from the remote disk, a data file of the one or more data files, the data file being last accessed by a user; segmenting the data file into data blocks; caching the data blocks into a local disk; and caching the data blocks from the local disk to a local memory.

### CROSS-REFERENCE TO RELATED APPLICATION

The present disclosure claims the benefits of priority to International Application No. PCT/CN2018/110968, filed on Oct. 19, 2018, which claims priority to Chinese Patent Application No. 201711036438.5 filed on Oct. 30, 2017, both of which are incorporated herein by reference in their entireties.

### BACKGROUND

For an analytic database (Analytic DB), all data involved in computation is imported from an external data source (such as a distributed file system) into computing nodes prior to computation, and then local data is read during the computation. This can reduce the network overhead of the computation process.

Because the local capacity of the analytic database is limited, and a large number of data files need to be stored prior to computation, some conventional systems increase computing nodes in the analytic database to expand its storage capacity. But increasing computing nodes can inevitably increase the use cost of a user.

In some conventional systems, data is divided into cold data (data accessed infrequently) and hot data (data accessed frequently) for hierarchical storage by setting some conditions in the analytic database in advance. The hot data is stored at high levels (e.g., a local SSD) of the analytic database, and the cold data is stored at low levels (e.g., a local HDD). On one hand, database capacity is still limited, while on the other hand, these conditions cannot be updated dynamically with user accesses. Therefore, the distribution of cold and hot data is not accurate enough, and the hierarchical storage is not flexible enough.

Although the analytic database can support hierarchical storage, its data hierarchical granules are files, and the granularity is relatively large. On one hand, the cold and hot data in the files cannot be hierarchically stored, on the other hand, the loading speed and computing speed of data can be reduced, and meanwhile, a large quantity of network resources is wasted.

### SUMMARY

Embodiments of the present disclosure can provide a method and an apparatus for data hierarchical storage. The method comprises: storing one or more data files in a remote disk; acquiring, from the remote disk, a data file of the one or more data files, the data file being last accessed by a user, segmenting the data file into data blocks, and caching the data blocks into a local disk; and caching the data blocks from the local disk to a local memory.

### BRIEF DESCRIPTION OF THE DRAWINGS

The accompanying drawings described herein are used to provide further understanding of the present disclosure and constitute a part of the present disclosure. Exemplary embodiments of the present disclosure and descriptions of the exemplary embodiments are used to explain the present disclosure and are not intended to constitute inappropriate limitations to the present disclosure. In the accompanying drawings:

FIG. 1 is a schematic diagram of an exemplary application environment, consistent with some embodiments of the present disclosure.

FIG. 2 is a flowchart of an exemplary data hierarchical storage method, consistent with some embodiments of the present disclosure.

FIG. 3 is a flowchart of an exemplary data hierarchical search method, consistent with some embodiments of the present disclosure.

FIG. 4 is a flowchart of an exemplary data hierarchical search method, consistent with some embodiments of the present disclosure.

FIG. 5 is a schematic structural diagram of an exemplary data hierarchical storage apparatus, consistent with some embodiments of the present disclosure.

FIG. 6 is a schematic diagram of an exemplary hierarchical structure of computing nodes in an analytic database and exemplary interactions between the computing nodes and a remote disk, consistent with some embodiments of the present disclosure.

FIG. 7 is a schematic diagram of an exemplary hierarchical structure of computing nodes in an analytic database and exemplary interactions between the computing nodes and a remote disk, consistent with some embodiments of the present disclosure.

FIG. 8 is a schematic diagram of exemplary capacity shrinkage and capacity expansion, consistent with some embodiments of the present disclosure.

FIG. 9 is a schematic diagram of an exemplary data access process in a hierarchical storage mode of data blocks, consistent with some embodiments of the present disclosure.

### DETAILED DESCRIPTION

To facilitate understanding of the solutions in the present disclosure, the technical solutions in some of the embodiments of the present disclosure will be described with reference to the accompanying drawings. It is appreciated that the described embodiments are merely a part of rather than all the embodiments of the present disclosure. Consistent with the present disclosure, other embodiments can be obtained without departing from the principles disclosed herein. Such embodiments shall also fall within the protection scope of the present disclosure.

In a typical configuration, a computing device of a client or server includes one or more central processing units (CPUs), an input/output interface, a network interface, and a memory.

The memory may include computer readable media such as a volatile memory, a Random Access Memory (RAM), and/or a non-volatile memory, e.g., a Read-Only Memory (ROM) or a flash RAM. The memory is an example of a computer readable medium. The memory may include a module 1, a module 2, and a module N (N is an integer greater than 2).

The computer readable medium includes non-volatile and volatile media as well as movable and non-movable media and can implement information storage by means of any method or technology. The information may be a computer readable instruction, a data structure, and a module of a program or other data. Examples of the storage medium of a computer include, but are not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and can be used to store information accessible to the computing device. According to the definition herein, the computer readable medium does not include transitory media, such as a modulated data signal and a carrier.

In some conventional systems, an analytic database only supports a pre-storage mode in which a large number of data files of a user is stored locally in advance by the analytic database prior to computation. The mode has at least the following defects. 1. A large number of data files are stored locally, which takes up a large amount of local space. However, due to the limited local capacity of the analytic database, computing nodes need to be increased when the user data volume is large, which inevitably increases the use costs of the user. 2. The process of data import is slow, the time cost is high when the amount of data imported by the user is very large, and the importing process consumes a large quantity of network resources, which indirectly affects the stability of services of the analytic database. 3. There may be a large amount of cold data in the data files imported by the user, which will not only take up the local storage space, but also affect the computing speed. 4. In the process of computation, since the computing nodes read data in units of files, the granularity is high and the reading efficiency is low; if the hot data and the clod data coexist in a data file, data unnecessary for the computation may also be read, which not only affects the loading speed and computing speed of data but also can waste a large quantity of network resources.

In some conventional systems, the data files can be stored in the analytic database according to popularity degrees, but cold and hot blocks inside the files cannot be hierarchically stored. This inevitably causes low loading speed and low computing speed of the data and also wastes network resources due to the transmission of a large number of large-granularity data files.

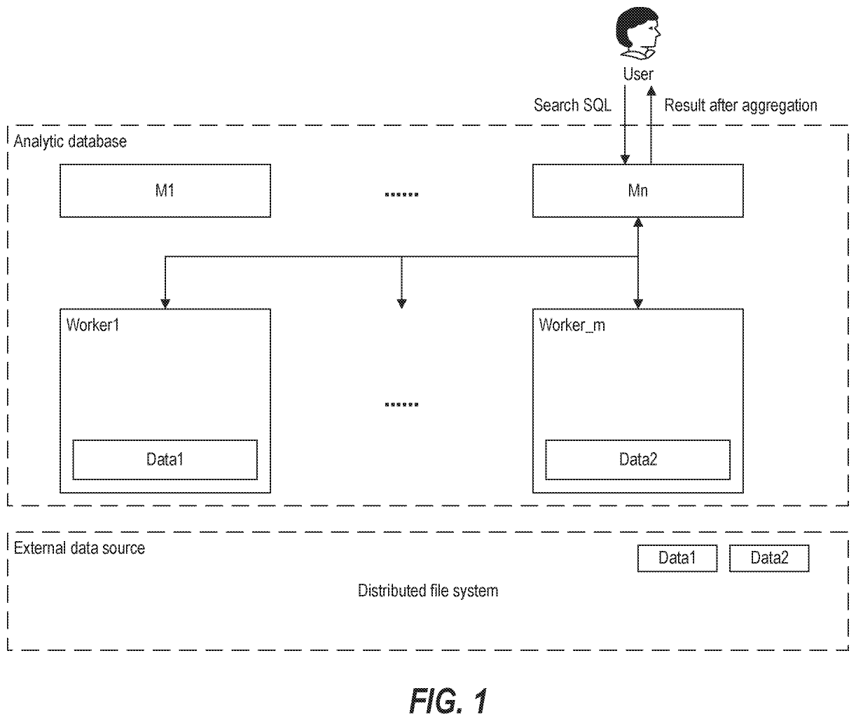

FIG. 1 is a schematic diagram of an exemplary application environment, consistent with some embodiments of the present disclosure. As shown in FIG. 1, an analytic database can include a plurality of aggregation nodes (M1, . . . , Mn, where n is an integer not smaller than 2) and a plurality of computing nodes (Worker1, . . . , Worker_m, where m is an integer not smaller than 2). Each of the aggregation nodes is responsible for interacting with a user, splitting a task submitted by the user and sending the split tasks to various computing nodes. The computing node performs the task sent by the aggregation node and feeds a computation result back to the aggregation node. The aggregation node combines the computation results fed back by the computing nodes and then provide the combined computation result to the user. When performing search computation, the computing nodes in the analytic database can directly copy data from an external data source (e.g., a distributed file system) to a local location, and then read corresponding data files from the local location. For example, in need of searching for data, the user can send a search SQL to the aggregation node Mn; the aggregation node Mn splits the corresponding search task into subtasks and distributes them to Worker1 and Worker_m. Worker1 and Worker_m perform a search respectively, and Worker1 and Worker_m can directly copy Data1 and Data2 from an external data source respectively, then perform search computation on Data1 and Data2, and finally return the results of search computation to the aggregation node Mn. The aggregation node Mn aggregates the results returned by Worker1 and Worker_m and then returns the aggregated result to the user.

The technical solutions of this disclosure are described in detail below. It should be noted that the following technical solutions of this disclosure can be applied to (but not limited to) the analytic database. In addition, they can also be applied to other types of databases, which is not limited herein.

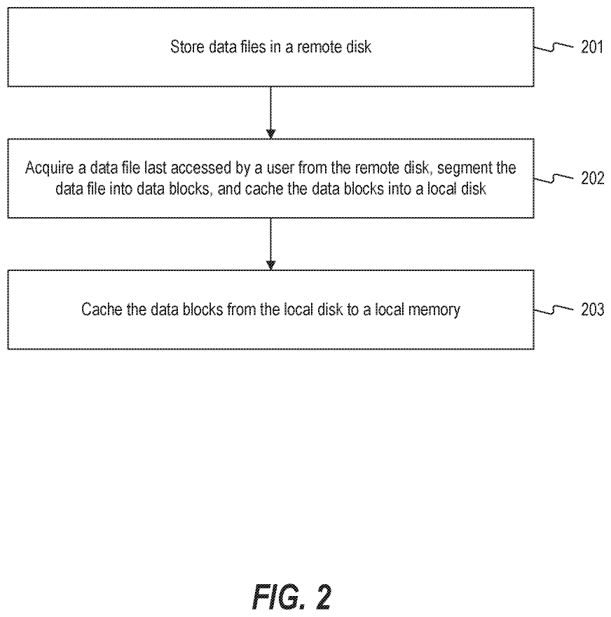

As shown in FIG. 2, a data hierarchical storage method can include the following steps.

In step 201, data files are stored in a remote disk.

In step 202, a data file last accessed by a user is acquired from the remote disk, the data file is segmented into data blocks, and the data blocks are cached in a local disk.

In step 203, the data blocks are cached from the local disk to a local memory.

In some embodiments, the data file last accessed by the user is segmented into data blocks that are hierarchically stored locally, so that the analytic database can dynamically update the data hierarchically stored locally according to changes in user access. Accordingly, hot data is hierarchically stored in the form of small-granularity data blocks according to actual popularity of data access. The distribution and hierarchical storage of the cold and hot data are more in line with the actual data access situation, and hierarchical storage can be automatically performed according to popularity of data blocks inside a file. As such, not only can the loading speed and computing speed of data be greatly increased, but also data files need to be frequently transmitted between the analytic database and user equipment and between the analytic database and the remote disk, thereby saving a large quantity of network resources.

In some embodiments, the local memory and the local disk belong to the analytic database. In case of hierarchical storage, the local memory is taken as high level, and the local disk is taken as low level. When the analytic database is accessed, data blocks are acquired from the local memory preferentially, and are acquired from the local disk if the local memory does not have the data blocks. If the local disk does not have the data blocks, it indicates that the data blocks are not in the local analytic database. In this case, the corresponding data file is acquired from the remote disk, and the data file is segmented into data blocks which are stored in the local disk and the local memory in turn.

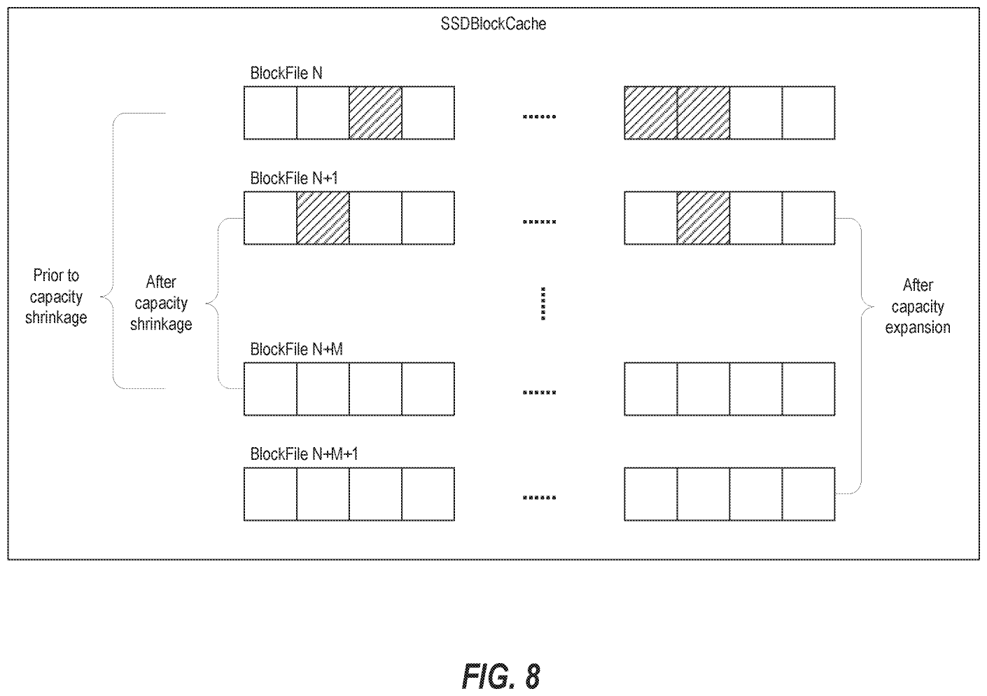

In some embodiments, the data blocks can be stored in the form of a block file (e.g., BlockFile of FIG. 8) in the local disk. At least one fixed-length BlockFile can be created in the local disk. The BlockFile includes fixed-length Blocks. The step of caching the data blocks into a local disk can include: caching the data blocks into empty Blocks of the local disk.

In an implementation, a mapping relationship can be configured in the local disk. The mapping relationship includes at least the length of the data blocks, an address of each Block and an address of a file to which data content in the Block belongs, and other information. A data file from the remote disk can be segmented into fixed-length data blocks through the mapping relationship, and then the data blocks are stored in empty Blocks in the local disk. For example, a data file is 10 G, and the length of one Block is set to 128 KB. Therefore, the data file can be segmented into 81920 data blocks. The granularity of the data blocks can be much smaller than that of the data file.

In an implementation, a plurality of BlockFiles can be created in a local SSD. Each BlockFile is a fixed-length file. Each BlockFile is internally divided into fixed-length Blocks, and the state of each Block is recorded. Here, a Block can have two states: an empty state indicating that no data has been stored in the Block, and a full state indicating that the Block is full of data. As such, when data blocks need to be cached into the local disk, empty Blocks can be searched, and the data blocks can be stored in the empty Blocks.

For example, when the system is started up, BlockFiles can be created according to the available capacity (which is 700 GB by default) of the local disk. If the length of one BlockFile is set to 1 GB and the length of one Block is set to 128 KB, and if all available capacity of the local disk is available for storage of data blocks, 700 BlockFiles can be created, each of which is internally divided into 8192 Blocks. If the length of one Block is set to 256 KB, each BlockFile can be internally divided into 4096 Blocks. It is thus clear that the data is cached into the local disk in Blocks, and the Block-level caching is more beneficial to aggregating hot data than the file-level hierarchy of cold and hot data. For example, for a data file of 10 GB, only 1 G or hundreds of KB therein can be desired for search computation, the desired small portion of the data can be directly loaded when the data is cached at the Block level, and the 10 G data file needs to be loaded for the file level cold and hot hierarchy. Therefore, the method in some embodiments can greatly increase the loading speed and computing speed of data in comparison to some conventional systems.

In an implementation, the process of caching data blocks for one computation or search in the local disk can be as follows: if there are successive empty Blocks, the successive Blocks are automatically used to store the data for the current computation or search preferentially. If the local disk has empty blocks that are not successive, these non-successive empty blocks can be automatically used to store the data for the current computation or search. In some embodiments, the local disk supports random reading, so whether the data is stored in successive blocks does not affect the reading efficiency. For example, before user access has occurred, the local disk can be empty; in this case, the local disk can split each data file acquired from the remote disk into data blocks and then store the data blocks in a plurality of successive Blocks or BlockFiles. For another example, after multiple user accesses, some empty blocks can exist in the local disk, but these blocks are non-successive and can belong to different BlockFiles; in this case, the data blocks can also be directly stored into these non-successive but empty blocks.

In some embodiments, when new data needs to be loaded, if the local disk does not have enough Blocks to cache the new data, some of the Blocks in the local disk can be emptied to cache the new data. That is, before the data blocks are cached into the local disk and when all Blocks of the local disk are full, a least recently used (LRU) algorithm can be used to eliminate the data in a part of the blocks to empty the part of the Blocks, so as to cache the data blocks into the part of the Blocks.

In an implementation, the local disk can, based on the required capacity of data blocks that need to be cached currently and current states (empty or full) of the blocks of the local disk, empty a part of the Blocks using the LRU algorithm so as to store the data blocks in the part of the Blocks. As such, by loading the data multiple times, the data blocks cached into the local disk are data accessed frequently, that is, hot data.

In some embodiments, the data blocks or the data blocks and data files can be stored in the local memory in a form similar to that in the local disk. In an implementation, the data blocks can be stored in the local memory in the form of BlockFile. That is, at least one fixed-length BlockFile is also created in the local memory, the BlockFile including fixed-length Blocks. Here, the manner in which the data blocks are stored in the local memory is the same as that in the local disk.

In some embodiments, when new data needs to be loaded, if the local memory does not have enough space to cache the new data, the local memory can also empty some of its own Blocks to cache the new data. Specifically, before the data blocks are loaded from the local disk to the local memory for caching, when all Blocks in the local memory are full, the LRU algorithm can be used to eliminate the data in a part of the Blocks to empty the part of the blocks, so that the data blocks can be stored in the part of the Blocks.

In an implementation, the local memory can, based on the required capacity of data blocks that need to be cached and current states (empty or full) of the blocks of the local memory, empty a part of the Blocks using the LRU algorithm so as to store the data blocks that need to be cached in the part of the Blocks. As such, by multiple times of loading, the data cached into the local memory can be data accessed frequently, that is, hot data.

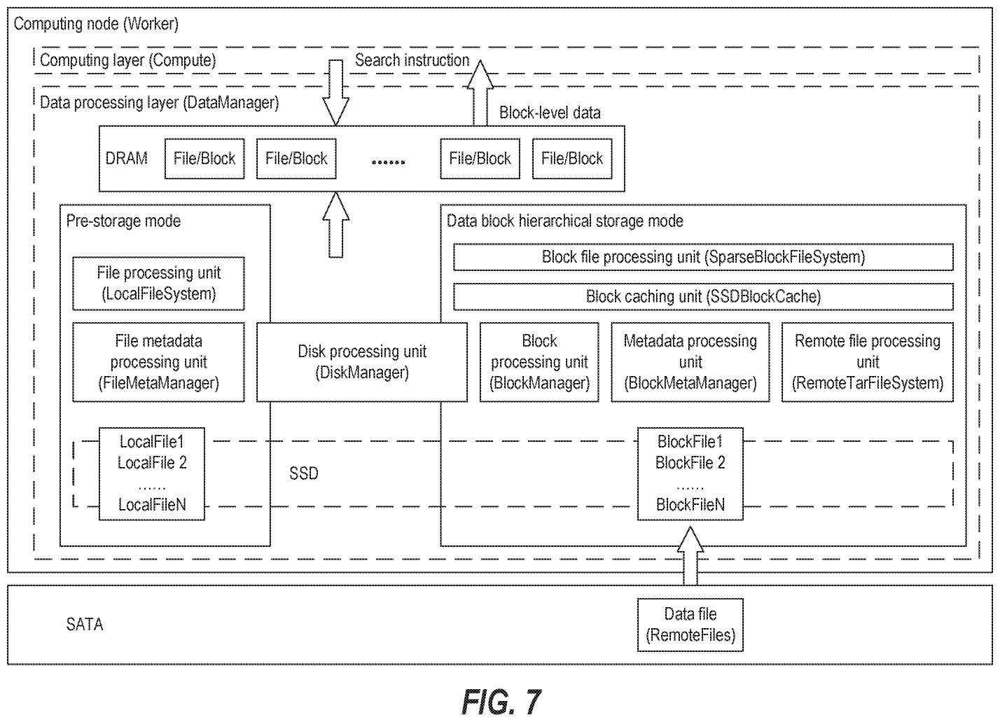

In some embodiments, at least one local file (e.g., LocalFile of FIG. 7) can also be created in the local disk, and the LocalFile is used to store a data file. The method further includes: caching a pre-designated data file in the LocalFile of the local disk. As such, a part of the data can be stored in the analytic database in a pre-storage mode according to requirements of a scenario or the user, so that the analytic database can also be applied to scenarios where real-time performance is required, such as monitoring.

In an implementation, the local disk can be partitioned to support both pre-storage of a data file and hierarchical storage of data blocks through different partitions. That is, the local disk can include a block cache where the BlockFile is created and a file cache where the LocalFile is created. As such, the hierarchical storage of the data blocks described above can be implemented in the block cache and the local memory, and the pre-storage mode described above can be implemented in the file cache and the local memory.

In some embodiments, the capacity of the block cache in the local disk can also be expanded or shrunk by scanning the used capacity of the file cache in the local disk.

In an implementation, the step of expanding or shrinking the capacity of the block cache in the local disk can include at least one of the following: 1) increasing the capacity of the block cache correspondingly according to the releasable capacity of the file cache, and creating the BlockFile or the Blocks in the block cache according to the new capacity; and 2) deleting a part of the BlockFile or the Blocks in the block cache according to the capacity that needs to be increased in the file cache, and shrinking the capacity of the block cache correspondingly.

For example, the priority of the pre-storage mode can be set to be higher than that of the data block hierarchical storage mode when the pre-storage mode and the data block hierarchical storage mode coexist. When the capacity needs to be expanded in the pre-storage mode due to the increase of data files, the storage space in the data block hierarchical storage mode needs to be released for the pre-storage mode. In this case, the capacity of the block cache in the local disk can be shrunk automatically. When less storage space is occupied in the pre-storage mode due to the reduction of data files, the redundant storage space in the pre-storage mode can be released for use in the data block hierarchical storage mode. That is, the storage space released in the pre-storage mode can be used to automatically expand the capacity of the block cache in the local disk.

Due to the large capacity of the block cache, if the computing nodes are restarted, the warm-up time can be very long, which can inevitably affect the search performance. In order to avoid this problem, in some embodiments, the block cache can also be persisted by a write ahead log (WAL), that is, before the data blocks are cached into the local disk, a WAL corresponding to the BlockFile can be set in the block cache of the local disk. As such, after the computing nodes are restarted, the block cache can be quickly warmed up by replaying the log.

In an implementation, the process of persisting the block cache by a WAL can be storing metadata in the block cache, wherein the metadata is divided into two parts: one is used to record which Blocks have been allocated and which Blocks have not been allocated, namely, states of the Blocks, and the other part is used to record to which BlockFile each Block belongs, namely, subordination relationships between the Blocks and the BlockFiles. As such, when the computing nodes are restarted, the data cached in each BlockFile can be completely recovered through the metadata with no need of retrieval. If the metadata is not saved, all the data in the BlockFile can be automatically emptied. In this case, the data file further needs to be acquired, segmented and cached again, which can affect the search computation speed of the data and even affect the performance of the analytic database.

In some embodiments, the method further includes: during access by the user, searching for corresponding data blocks recursively downward from the local memory, the local disk to the remote disk layer by layer, and meanwhile, caching the data blocks into the local memory and the local disk layer by layer.

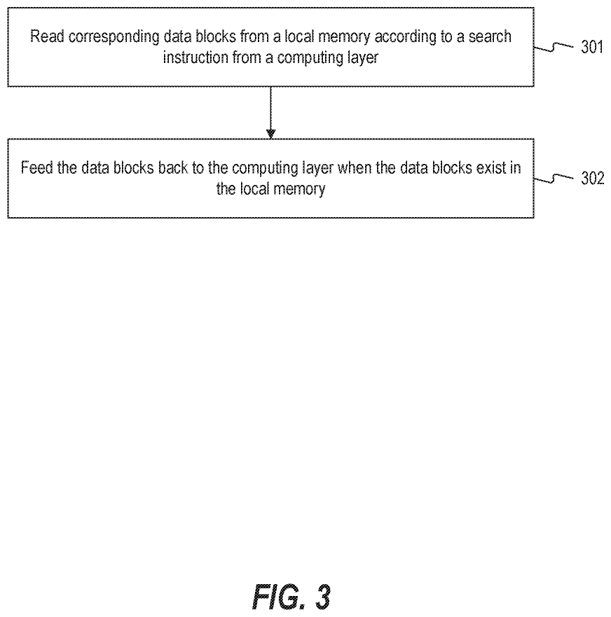

In an implementation, on the basis of the above data hierarchical storage method, a data hierarchical search method applied to the above analytic database is further provided in some embodiments. With the data hierarchical search method, corresponding data blocks can be searched for recursively downward from a local memory, a local disk to a remote disk layer by layer, and meanwhile, the data blocks are cached in a local memory and a local disk layer by layer. As shown in FIG. 3, the data hierarchical search method can include the following steps.

In step 301, data blocks are read from the local memory according to a search instruction from a computing layer.

In step 302, the data blocks are fed back to the computing layer when the data blocks exist in the local memory.

In an implementation, after the corresponding data blocks are read from the local memory, the method can further include: when the data blocks do not exist in the local memory, reading the data blocks from the local disk; when the data blocks exist in the local disk, loading the data blocks from the local disk to the local memory; and reading the data blocks from the local memory again.

In an implementation, after the corresponding data blocks are read from the local disk, the method can further include: when the data blocks do not exist in the local disk, reading a corresponding data file from a remote disk, segmenting the data file into data blocks, and caching the data blocks into the local disk; loading the data blocks from the local disk to the local memory; and reading the data blocks from the local memory again.

In an implementation, the user can control, through indications, whether the data being searched for enters a corresponding storage layer. For example, the user can input the following search SQL:/*+MemBlockCache=false, SSDBlockCache=false*/select * from table1. The search SQL means: when SSDBlockCache=false, it indicates that the data does not enter a local SSD cache; and when MemBlockCache=false, it indicates that the data does not enter a local memory cache. In an actual application, data searched by user is cached by default. By providing similar functions, the user can prevent, through the search SQL, some search results from entering the cache as needed, thus avoiding invalid swap-in and swap-out of the cache.

The above data hierarchical search method can be implemented in any computing node of the analytic database. When the computing layer of the computing node reads data from the data processing layer (concurrency is not considered), the data is first acquired from the top layer, namely, the local memory. If not hit, the data is acquired recursively downward from a lower layer, namely, the local disk and the remote disk, until the desired data is acquired. The corresponding data is cached into the corresponding storage hierarchy during the search.

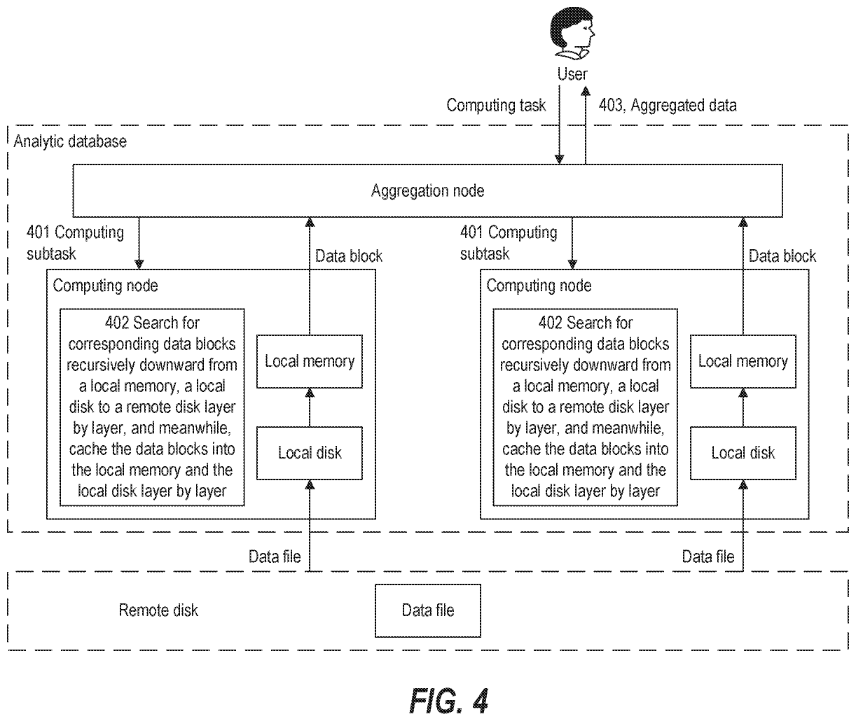

On the basis of the above data hierarchical storage method, another data hierarchical search method applicable to an analytic database is further provided in some embodiments. As shown in FIG. 4, the data hierarchical search method can include the following steps.

In step 401, an aggregation node splits a computing task from user equipment into computing subtasks and distributes the computing subtasks to various computing nodes.

In step 402, the computing nodes perform the following operations by performing the computing subtasks: searching for corresponding data blocks recursively downward from a local memory, a local disk to a remote disk layer by layer, and meanwhile, caching the data blocks into the local memory and the local disk layer by layer, and returning the obtained data blocks to the aggregation node.

In step 403, the aggregation node aggregates the data blocks returned by the computing nodes and then provides the aggregated data blocks to the user equipment.

In an implementation, the computing nodes can further perform the following operation by performing the computing subtasks: storing data files in a remote disk.

In an implementation, the step of searching for corresponding data blocks recursively downward from a local memory, a local disk to a remote disk layer by layer, and meanwhile, caching the data blocks into the local memory and the local disk layer by layer can include: when the data blocks are not obtained in either the local memory or the local disk, acquiring the corresponding data file from the remote disk, segmenting the data file into data blocks, and caching the data blocks on the local disk; and loading the data blocks from the local disk to the local memory for caching.

In an implementation, searching for corresponding data blocks recursively downward from a local memory, a local disk to a remote disk layer by layer, and meanwhile, caching the data blocks into the local memory and on the local disk layer by layer by the computing nodes can be implemented with the data hierarchical search method shown in FIG. 3.

The computing nodes read corresponding data blocks from the corresponding local memory by performing the search subtasks, and the data blocks are fed back to the aggregation node when the data blocks exist in the local memory.

The aggregation node aggregates the data blocks fed back by the computing nodes and then provides the aggregated data blocks to the user equipment.

In an implementation, after the corresponding data blocks are read from the corresponding local memory of the analytic database, the method can further include: when the data blocks do not exist in the local memory, reading the data blocks from the corresponding local disk; when the data blocks exist on the local disk, loading the data blocks from the local disk to the local memory for caching; and reading the data blocks from the local memory again.

In an implementation, after the data blocks are read from the local disk of the analytic database, the method can further include: when the data blocks do not exist in the local disk, reading a corresponding data file from a remote disk, segmenting the data file into data blocks, and caching the data blocks in the corresponding local disk; loading the data blocks from the local disk to the local memory for caching; and reading the data blocks from the local memory again.

It should be noted that the above data hierarchical search method can further include: performing, by the computing nodes, the following operations by performing the computing subtasks: recursively searching for a designated data file downward from the local memory to the local disk and the remote disk layer by layer, and meanwhile, caching the data file into the local memory.

The above method of some embodiments is described in detail below through the following example. It is assumed that a user wants to keep data in the past 100 days and imports new data into a custom analytic database every day. If the user sets that the analytic database adopts a pre-storage mode and a data block hierarchical storage mode simultaneously, and the data stored every day is stored in the data block hierarchical storage mode by default, then in the analytic database, the data stored by the user every day is stored in the remote disk by default in the form of data files.

When the user searches for some specific data for the first time, the analytic database can acquire a corresponding data file from the remote disk, segment the data file into data blocks, cache the data blocks in empty Blocks of various BlockFiles of the local disk in the analytic database, and load the data blocks from the local disk to a local memory of the analytic database for caching.

After multiple searches, the data often accessed by the user is cached into the local disk and into the local memory in the form of data blocks. When the user searches for such data again, the computing nodes of the analytic database can read the data directly from the local disk or the local memory, and the data read is at the Block level, which not only makes the search fast, but also makes the search cost of the user lower.

In general, the user often searches for the data accessed in recent days and can search for the data stored a longer time ago only in special cases.

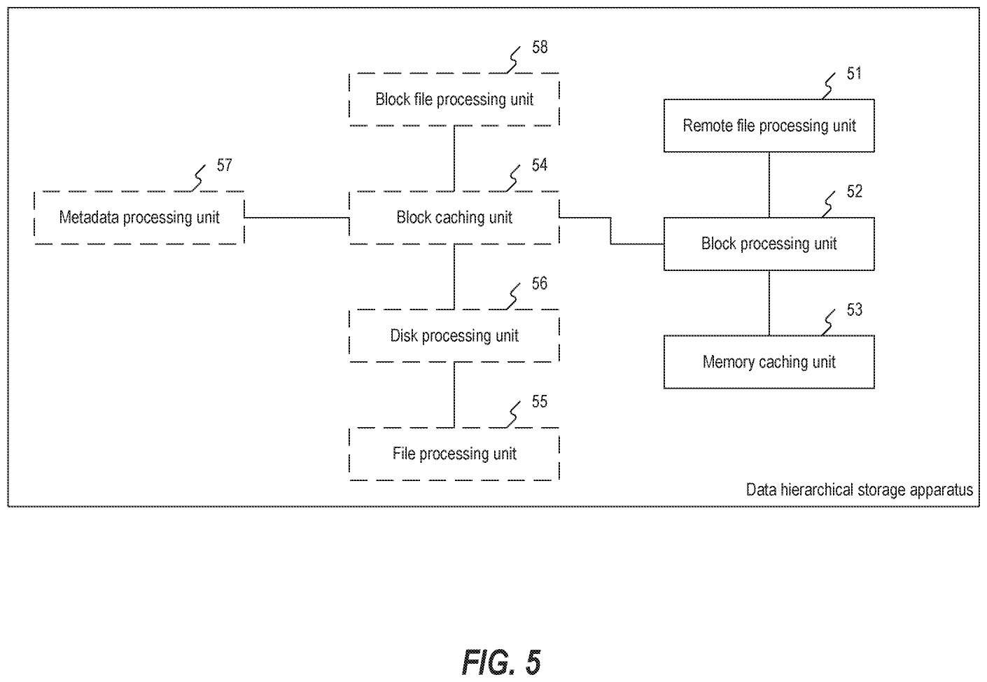

If the user needs data stored a long time ago and such data is accessed less frequently, it is likely that the data is not cached into the local disk or into the local memory. When the user searches for such data, the computing nodes of the analytic database can search the local disk and the local memory downward layer by layer, and the computing nodes can need to acquire a corresponding data file from the remote disk, then segment the data file into data blocks and store the data blocks into the local disk and the local memory, and finally provide the data to the user in the form of data blocks. Searching for such data can be slow at the first time. However, the corresponding data can also be cached into the local disk and the local memory after having been searched for once. If the user often accesses such data subsequently, the data can be cached into the local disk and the local memory for a long time as hot data, and its loading speed and computing speed can be increased as the number of accesses increases. As shown in FIG. 5, a data hierarchical storage apparatus can include a remote file processing unit 51, a block processing unit 52, and a memory caching unit 53.

Remote file processing unit 51 is configured to store data files in a remote disk, and acquire a data file last accessed by a user from the remote disk.

Block processing unit 52 is configured to segment the data file into data blocks, and cache the data blocks into a local disk.

Memory caching unit 53 is configured to load the data blocks from the local disk to a local memory for caching.

In an implementation, the above data hierarchical storage apparatus can further include: a block caching unit 54. Block caching unit 54 is configured to create at least one fixed-length BlockFile that includes at least fixed-length Blocks in the local disk, and the block processing unit 52 is configured to cache the data blocks into the empty Blocks.

In an implementation, the above data hierarchical storage apparatus can further include: a file processing unit 55. File processing unit 55 is configured to create at least one LocalFile for storing data files in the local disk; and configured to cache a pre-designated data file in the LocalFile of the local disk.

In an implementation, the local disk includes a block cache where the BlockFile is created and a file cache where the LocalFile is created; and the above data hierarchical storage apparatus can further include: a disk processing unit 56. Disk processing unit 56 is configured to expand or shrink the capacity of the block cache in the local disk by scanning the used capacity of the file cache in the local disk.

In an implementation, the above data hierarchical storage apparatus can further include: a metadata processing unit 57. Metadata processing unit 57 is configured to set a WAL corresponding to the BlockFile on the local disk.

In an implementation, the above data hierarchical storage apparatus can further include: a block file processing unit 58. Block file processing unit 58 is configured to, during access by the user, search for corresponding data blocks recursively downward from the local memory, the local disk to the remote disk layer by layer. Block caching unit 54 can be further configured to cache the data blocks into the local memory and the local disk layer by layer in the process of searching for the data blocks by the block file processing unit.

Other technical details of some embodiments can be obtained with reference to various examples hereinafter.

A computing device can include: a communication circuit, a data storage, a storage, and a processor. The communication circuit is configured to communicate with a remote disk, the data storage supports a hierarchical storage mode, includes a local disk as low level and local memory as high level, a data hierarchical storage program is stored in the storage, and the processor is configured to read the data hierarchical storage program for performing the operations of the data hierarchical storage method consistent with some embodiments of the present disclosure.

In an implementation, the processor is further configured to read the data hierarchical storage program for performing the following operations: during access by the user, searching for corresponding data blocks recursively downward from the local memory, the local disk to the remote disk layer by layer, and meanwhile, caching the data blocks into the local memory and the local disk layer by layer.

Other technical details of some embodiments can be obtained with reference to various examples throughout.

A distributed computing system includes: at least one aggregation node and a plurality of computing nodes, the aggregation node is configured to split a computing task from user equipment into computing subtasks and distribute the computing subtasks to the computing nodes; and aggregate the data blocks returned by the computing nodes and then provide the aggregated data blocks to the user equipment; and the computing nodes are configured to perform the following operations by performing the computing subtasks: search for corresponding data blocks recursively downward from a local memory, a local disk to a remote disk layer by layer, and meanwhile, cache the data blocks into the local memory and the local disk layer by layer, and return the obtained data blocks to the aggregation node.

Other technical details of some embodiments can be obtained with reference to various examples throughout.

A computer readable storage medium storing a data hierarchical storage program, wherein when the data hierarchical storage program is executed by a processor, the steps of the data hierarchical storage method consistent with some embodiments are implemented.

Other technical details of some embodiments can be obtained with reference to various examples hereinafter.

Exemplary implementations of the above embodiments are described in detail below. It should be noted that the following examples can be combined with each other. Moreover, the processes, execution processes, and so on in the examples below can also be adjusted according to actual application requirements. In addition, the above embodiments can also be implemented in other manners in actual applications.

Some embodiments are described in detail below through a plurality of examples.

In an implementation solution, the local disk can be implemented as a Solid State Disk (SSD) with a high access speed, and the local memory can be implemented as a Dynamic Random Access Memory (DRAM) with a higher access speed. The remote disk can be implemented as a Distributed File System (DFS) where a large quantity of data can be stored, for example, a remote Serial Advanced Technology Attachment (SATA).

In this implementation solution, after the data is stored in a hierarchical storage mode: the DFS (remote SATA) stores all data files of a user; a local SSD of the analytic database: 1. stores data involved in computation, and manages the stored data according to data blocks; 2. caches different data files separately according to different popularity degrees; 3. divides data in a data file into cold data and hot data and caches the cold data and the hot data in the form of data blocks; and 4. clears the data using a LRU algorithm if necessary; and a local DRAM of the analytic database: stores hot data involved in the computation, the hot data being from the local SSD, and clears the stored data using the LRU algorithm if necessary.

In addition, the local memory, the local disk and the remote disk can also be implemented in other forms, and the specific implementation forms are not limited in this implementation.

In an implementation solution, the analytic database can support only a data block hierarchical storage mode which is hierarchical storage of the data blocks into the local disk and the local memory in some embodiments.

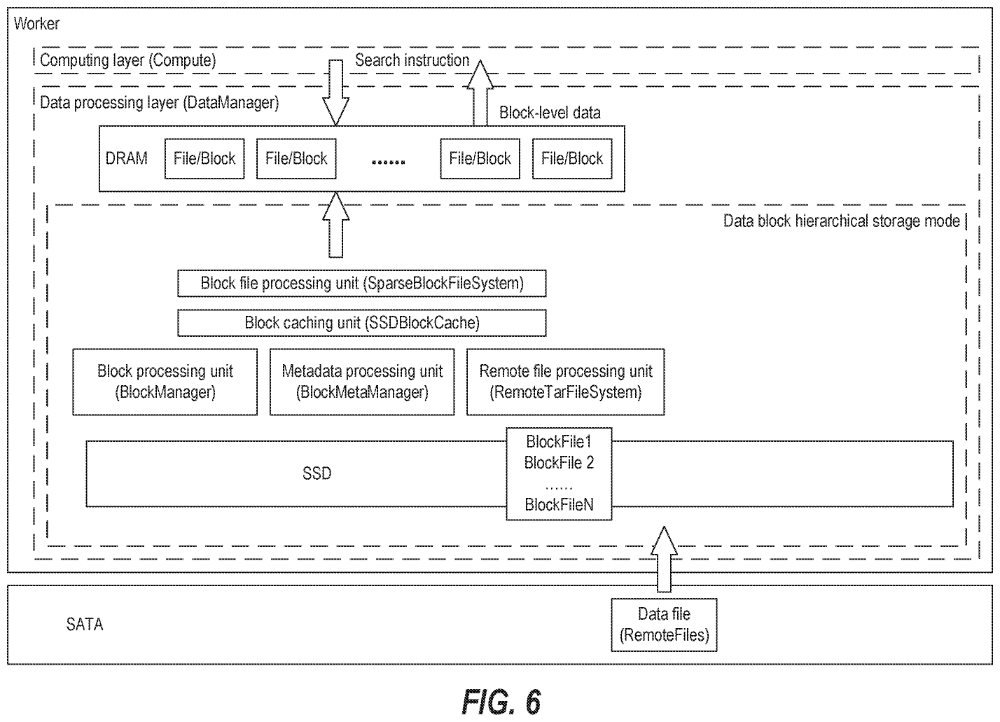

In this example, the DRAM is the memory of a computing node in the analytic database. As shown in FIG. 6, a schematic diagram of an exemplary hierarchical structure of computing nodes in an analytic database and exemplary interactions between the computing nodes and a remote disk, consistent with some embodiments of the present disclosure is provided. The SATA as a remote disk is responsible for storing all data files imported by a user. One computing node can include a computing layer (Compute) and a data processing layer (DataManager). The computing layer is responsible for invoking the data processing layer to search for a designated data block and making computation by performing a sub-task sent by the aggregation node, and feeding the computation result back to the aggregation node. The data processing layer is configured to search for the designated data block according to a search instruction of the computing layer.

As shown in FIG. 6, in this example, the data processing layer can include two layers: a high-level DRAM and a low-level SSD. A plurality of BlockFiles: BlockFile 1, BlockFile 2, . . . , and BlockFile N (N is an integer not smaller than 1) are created on the SSD. The data processing layer supports a data block hierarchical storage mode. In the data block hierarchical storage mode, when a data block last accessed by a user is not cached either in the DRAM or in the SSD, the data managing layer acquires a corresponding data file from the SATA, segments the data file into fixed-length data blocks, caches the data blocks in various Blocks inside BlockFiles in the SSD, and loads the data blocks to the DRAM for caching.

As shown in FIG. 6, the data processing layer can include the following functional units to implement hierarchical storage of the data blocks: a remote file processing unit, a block processing unit, a metadata processing unit, a block caching unit, and a block file processing unit.

The remote file processing unit is responsible for interacting with the SATA and can be configured to acquire a data file from the SATA.

The block processing unit is responsible for managing Block-level data and can be configured to segment the data file into fixed-length data blocks and to cache the data blocks in various Blocks inside BlockFiles in the SSD.

The metadata processing unit is configured to set WALs corresponding to the above BlockFiles on the SSD to record allocation of the Blocks and subordination relationship between the Blocks and the BlockFiles on the SSD, so that the data cached in the Blocks can be quickly recovered after the computing nodes are restarted.

The block caching unit is responsible for managing the BlockFiles and the Blocks on the SSD. The block caching unit can be configured to create the plurality of BlockFiles: BlockFile 1, BlockFile 2, . . . , and BlockFile N (N is an integer not less than 1) in the SSD, wherein each BlockFile is divided into a plurality of fixed-length Blocks, and can be further configured to, when invoked by the block processing unit and when all Blocks of the local disk are full, eliminate the data in a part of the Blocks using a LRU algorithm and clear the part of the Blocks, so that the block processing unit can cache the data blocks into the Blocks of the SSD.

The block file processing unit is responsible for interacting with the DRAM. The block file processing unit can be configured to search the SSD for corresponding data blocks when the data blocks do not exist in the DRAM, invoke the block file processing unit to acquire a corresponding data file from the SATA when the corresponding data blocks do not exist on the SSD, and finally load the obtained data blocks to the DRAM.

In an implementation solution, the analytic database can support a pre-storage mode and a data block hierarchical storage mode simultaneously. The data block hierarchical storage mode is a mode in which data blocks are hierarchically stored in the local disk and the local memory in some embodiments. The pre-storage mode is a mode in which the data file imported by the user into a local analytic database prior to the computation.

FIG. 7 is a schematic diagram of an exemplary hierarchical structure of computing nodes in an analytic database and exemplary interactions between the computing nodes and a remote disk, consistent with some embodiments of the present disclosure. As shown in FIG. 7, the hierarchical structure of the computing nodes and the hierarchical storage structure of the data processing layer in this example are the same as those in FIG. 6, except that the data processing layer of FIG. 7 can support the pre-storage mode and the data block hierarchical storage mode simultaneously. The SSD of the data processing layer is divided into two regions: a block cache and a file cache. A plurality of BlockFiles: BlockFile 1, BlockFile 2, . . . , and BlockFile N (N is an integer not less than 2) are created in the block cache, and a plurality of LocalFiles: BlockFile 1, BlockFile 2, . . . , and BlockFile X (X is an integer not less than 2) are created in the file cache.

In this example shown in FIG. 7, in the data block hierarchical storage mode, if a data block last accessed by a user is not cached in either the DRAM or the SSD, a corresponding data file can be acquired from the SATA, the data file is segmented into fixed-length data blocks, the data blocks are cached in various Blocks inside BlockFiles in the SSD, and finally the data blocks are loaded to the DRAM for caching.

In this example, in the pre-storage mode, the data processing layer can store a data file of a designated type imported by the user directly in the LocalFiles of the SSD, can acquire a corresponding data file directly from the LocalFiles at the moment of search, and after loading the data file to the DRAM for caching, read the data file from the DRAM and feed it back to the computing layer.

As shown in FIG. 7, in addition to including the functional units in FIG. 6, the data processing layer can also include the following functional units to support storage of the data file and hierarchical storage of the data blocks at the same time: a file processing unit and a file metadata processing unit.

The file processing unit is responsible for storing a designated data file imported by a user to various LocalFiles of the SSD.

The file metadata processing unit is responsible for recording metadata corresponding to the LocalFiles, wherein the metadata is used to record states of the LocalFiles (that is, whether storing a data file) to recover the data therein when the computing nodes are restarted.

FIG. 8 is a schematic diagram of exemplary capacity shrinkage and capacity expansion, consistent with some embodiments of the present disclosure. In this example, the capacity of the block cache is shrunk when the space needs to be released in the data block hierarchical storage mode for the expansion in the pre-storage mode. As shown in FIG. 8, prior to the capacity shrinkage, the following BlockFiles: BlockFile N, BlockFile N+1, . . . , BlockFile N+M, BlockFile N+M+1 (N and M are both integers not smaller than 1) are created in the block cache. After the capacity shrinkage, Block N is deleted from the block cache, but Block N+1, . . . , Block N+M, Block N+M+1 are retained. The capacity of the block cache can be expanded when a larger capacity can be used in the data block hierarchical storage mode as the capacity is shrunk in the pre-storage mode. As shown in FIG. 8, after the capacity expansion, a plurality of new BlockFiles are created in the expanded storage space by the block cache. Here, the Blocks in the shaded part in FIG. 8 are Blocks where data has been stored.

In an implementation solution, the data access process in the data block hierarchical storage mode, that is, the data hierarchical search process, can include: first reading data from the top layer, namely, the local memory, when the computing layer reads the data from the data processing layer; if the data is not hit, reading the data recursively downwards from a lower layer, namely, the local SSD and the DFS, until the data is read; and loading the data read from the lower layer into the local memory.

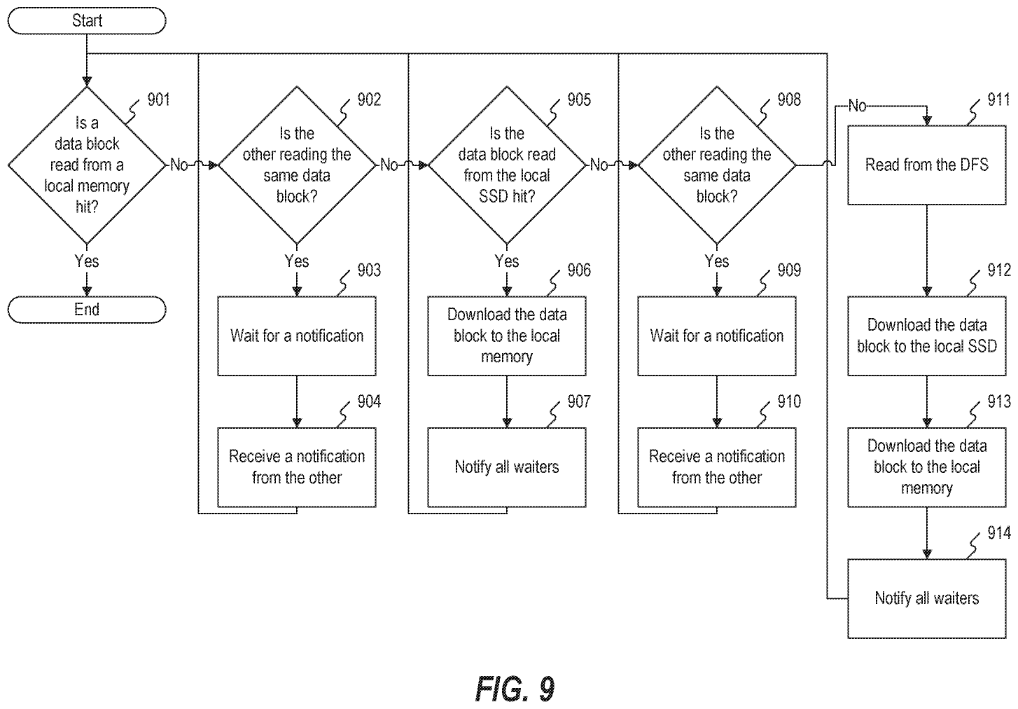

As shown in FIG. 9, the data access process in the data block hierarchical storage mode in this example can include the following steps.

In step 901, a data block is read from the local memory, it is judged whether the data block is hit, and the current process is directly ended if yes; otherwise, the process proceeds to step 902.

In step 902, it is judged whether the same data block is read in other processes (other), and the process proceeds to step 903 if the same data block is read in other processes. IF the same data block is not read in other processes, the process proceeds to step 905.

In step 903, a notification is waited for. If a notification is received, the process proceeds to step 904.

In step 904, a notification from the other is received, and the process goes back to step 901.

In step 905, the data block is read from the local SSD, it is judged whether the data block is hit, the process proceeds to step 906 if yes, and the process proceeds to step 908 if no.

In step 906, the data block is downloaded into the local memory.

In step 907, other processes waiting for reading the same data block (all waiters) are notified, and the process goes back to step 901.

In step 908, it is judged whether the other (other processes) is reading the same data block, and the process proceeds to step 909 if yes; otherwise, the process proceeds to step 911.

In step 909, a notification is waited for. If a notification is received, the process proceeds to step 910.

In step 910, a notification from the other is received, and the process goes back to step 901.

In step 911, the data block is read from the DFS.

In step 912, the data block read from the DFS is downloaded to the local SSD.

In step 913, the data block is downloaded from the local SSD to the local for caching.

In step 914, all waiters are notified, and the process goes back to step 901.

After considering the specification and practicing the invention disclosed here, those skilled in the art can easily think of other implementation solutions of this disclosure. This disclosure is intended to cover any variations, uses, or adaptive changes of this disclosure that follow the general principle of this disclosure and include common knowledge or common technical means in the art not disclosed in the present disclosure. The specification and embodiments are only considered exemplary and the true scope and spirit of this disclosure are indicated by the claims below.

It would be appreciated that this disclosure is not limited to the precise structure described above and shown in the accompanying drawings and can be modified and altered without departing from its scope. The scope of this disclosure is limited only by the appended claims.

It should be noted that in this text, the relation terms such as first and second are merely used to distinguish one entity or operation from another entity or operation, and do not require or imply that the entities or operations have this actual relation or order. Moreover, the terms “include,” “comprise” or other variations thereof are intended to cover non-exclusive inclusion, so that a process, method, article or device including a series of elements not only includes the elements, but also includes other elements not clearly listed, or further includes elements inherent to the process, method, article or device. In the absence of more limitations, an element defined by “including a/an . . . ” does not exclude that the process, method, article or device including the element further has other identical elements. This disclosure may be described in a common context of a computer executable instruction executed by a computer, for example, a program module. Generally, the program module includes a routine, a program, an object, an assembly, a data structure, and the like for executing a specific task or implementing a specific abstract data type. This disclosure may also be practiced in distributed computing environments, and in the distributed computer environments, a task is executed by using remote processing devices connected through a communications network. In the distributed computer environments, the program module may be located in local and remote computer storage media including a storage device.

The embodiments of the present disclosure are all described in a progressive manner, each embodiment emphasizes a difference between it and other embodiments, and identical or similar parts in the embodiments may be obtained with reference to each other. In particular, the apparatus embodiment is basically similar to the method embodiment, so that it is described simply. For related parts, refer to the descriptions of the parts in the method embodiment. The apparatus embodiments described above are merely schematic. The units described as separate parts may or may not be physically separate, and parts displayed as units may or may not be physical units, i.e., may be located in one position, or may be distributed on a plurality of network units. Some of or all the modules therein may be selected according to actual needs to achieve the objectives of the solutions of the embodiments. Those of ordinary skill in the art can understand and implement this disclosure without creative efforts. The above descriptions are merely specific implementations of this disclosure. It should be noted that those of ordinary skill in the art can also make several improvements and modifications without departing from the principle of this disclosure. The improvements and modifications should also be regarded as the protection scope of this disclosure.

1. A data hierarchical storage method, comprising:
storing one or more data files in a remote disk;
acquiring, from the remote disk, a data file of the one or more data files, the data file being last accessed by a user;
segmenting the data file into data blocks;
caching the data blocks into a local disk; and
caching the data blocks from the local disk to a local memory.

2. The data hierarchical storage method of claim 1, wherein
the local disk comprises at least one block file having a first fixed length, the at least one block file comprises blocks, each block having a second fixed length, wherein the blocks comprises at least one empty block, and
caching the data blocks into the local disk comprises: caching the data blocks into the at least one empty block of the local disk.

3. The data hierarchical storage method of claim 1, wherein the local disk comprises blocks, before caching the data blocks into the local disk, and the method further comprising:
in response to all blocks of the local disk being full, eliminating data in a first group of blocks of the local disk to clear the first group of blocks of the local disk.

4. The data hierarchical storage method of claim 1, wherein
the local memory comprises at least one block file having a second fixed length, the at least one block file comprises blocks, each block having a third fixed length; and
before caching the data blocks from the local disk to the local memory, the method further comprising: in response to all blocks of the local memory being full, eliminating data in a second group of blocks of the local memory to clear the second group of blocks of the local memory.

5. The data hierarchical storage method of claim 1, wherein
the local disk comprises at least one local file for storing data files, and
the method further comprising: caching a data file into the local file of the local disk.

6. The data hierarchical storage method of claim 5, wherein
the local disk comprises a block cache and a file cache, block files being created in the block cache, and the at least one local file being created in the file cache, and
after caching the data file into the local file of the local disk, the method further comprising: adjusting a size of the block cache in the local disk based on a size of a space occupied by the file cache in the local disk.

7. The data hierarchical storage method of claim 6, wherein adjusting the size of the block cache in the local disk based on the size of the space occupied by the file cache in the local disk comprises at least one of:
increasing the size of the block cache based on a released space of the file cache, and creating the block files or the blocks in the space released from the file cache and into the block cache; or
deleting at least one of a third group of block files or a fourth group of blocks in the block cache according to the space that needs to be added in the file cache, and reducing the size of the block cache.

8. The data hierarchical storage method of claim 1, wherein before caching the data blocks into the local disk, the method further comprising:
setting a write ahead log (WAL) corresponding to the block file in the local disk for storing metadata of the block file.

9. The data hierarchical storage method of claim 1, further comprising:
in response to a data access request, searching for corresponding data blocks recursively from the local memory, the local disk to the remote disk in order, and meanwhile, caching the data blocks into the local memory and the local disk in order.

10-12. (canceled)

13. A data hierarchical storage apparatus, comprising:
a memory storing a set of instructions; and
one or more processors configured to execute the set of instructions to cause the apparatus to perform:
storing one or more data files in a remote disk,
acquiring, from the remote disk, a data file of the one or more data files, the data file being last accessed by a user;
segmenting the data file into data blocks;
caching the data blocks into a local disk, and
caching the data blocks from the local disk to a local memory.

14. The data hierarchical storage apparatus of claim 13, wherein
the local disk comprises at least one block file having a first fixed length, the at least one block file comprises blocks, each block having a second fixed length, wherein the blocks comprises at least one empty block, and
caching the data blocks into the local disk comprises: caching the data blocks into the at least one empty block of the local disk.

15-24. (canceled)

25. A non-transitory computer readable medium that stores a set of instructions that is executable by at least one processor of a computer to cause the computer to perform a data hierarchical storage method, the method comprising:
storing one or more data files in a remote disk;
acquiring, from the remote disk, a data file of the one or more data files, the data file being last accessed by a user;
segmenting the data file into data blocks;
caching the data blocks into a local disk; and
caching the data blocks from the local disk to a local memory.

26. The non-transitory computer readable medium of claim 25, wherein
the local disk comprises at least one block file having a first fixed length, the at least one block file comprises blocks, each block having a second fixed length, wherein the blocks comprises at least one empty block, and
caching the data blocks into the local disk comprises: caching the data blocks into the at least one empty block of the local disk.

27. The non-transitory computer readable medium of claim 25, wherein the local disk comprises blocks, the at least one processor configured to execute the set of instructions to cause the computer to perform:
before caching the data blocks into the local disk, in response to all blocks of the local disk being full, eliminating data in a first group of blocks of the local disk to clear the first group of blocks of the local disk.

28. The non-transitory computer readable medium of claim 25, wherein
the local memory comprises at least one block file having a second fixed length, the at least one block file comprises blocks, each block having a third fixed length; and
the at least one processor configured to execute the set of instructions to cause the computer to perform: before caching the data blocks from the local disk to the local memory, in response to all blocks of the local memory being full, eliminating data in a second group of blocks of the local memory to clear the second group of blocks of the local memory.

29. The non-transitory computer readable medium of claim 25, wherein
the local disk comprises at least one local file for storing data files, and the at least one processor configured to execute the set of instructions to cause the computer to perform: caching a data file into the local file of the local disk.

30. The non-transitory computer readable medium of claim 29, wherein
the local disk comprises a block cache and a file cache, block files being created in the block cache, and the at least one local file being created in the file cache, and
the at least one processor configured to execute the set of instructions to cause the computer to perform: after caching the data file into the local file of the local disk, adjusting a size of the block cache in the local disk based on a size of a space occupied by the file cache in the local disk.

31. The non-transitory computer readable medium of claim 30, wherein
adjusting the size of the block cache in the local disk based on the size of the space occupied by the file cache in the local disk comprises at least one of:
increasing the size of the block cache based on a released space of the file cache, and creating the block files or the blocks in the space released from the file cache and into the block cache; or
deleting at least one of a third group of block files or a fourth group of blocks in the block cache according to the space that needs to be added in the file cache, and reducing the size of the block cache.

32. The non-transitory computer readable medium of claim 25, wherein the at least one processor configured to execute the set of instructions to cause the computer to perform:
before caching the data blocks into the local disk, setting a write ahead log (WAL) corresponding to the block file in the local disk for storing metadata of the block file.

33. The non-transitory computer readable medium of claim 25, wherein the at least one processor configured to execute the set of instructions to cause the computer to perform:
in response to a data access request, searching for corresponding data blocks recursively from the local memory, the local disk to the remote disk in order, and meanwhile, caching the data blocks into the local memory and the local disk in order.

34-37. (canceled)
